(19) United States
(12) Patent Application Publication
(10) Pub. No.: US 2017/0140371 A1
(43) Pub. Date: May 18, 2017

(54) MULTIPLE PAYMENT RAIL GATEWAY AND ROUTER

(71) Applicant: Align Commerce Corporation, San Francisco, CA (US)

(72) Inventors: Marwan Forzley, Sausalito, CA (US); Aldo Mario Eduardo S. Carrascoso, Daly City, CA (US)

(21) Appl. No.: 14/942,216

(22) Filed: Nov. 16, 2015

(51) Int. Cl. G06Q 20/38; G06Q 20/06

(52) U.S. Cl. CPC G06Q 20/381; G06Q 20/06; G06Q 2220/00

(57) ABSTRACT

A payment processor receives a first fiat-currency amount and information comprising a payee deposit destination. The payment processor receives a first plurality of criteria and evaluates a first plurality of exchanges against the first plurality of criteria to select a first transaction exchange from the first plurality of exchanges to initiate a first conversion between a first fiat-currency amount and a crypto-currency amount. The payment processor receives a second plurality of criteria and evaluates a second plurality of exchanges against the second plurality of criteria. The payment processor selects a second transaction exchange from the second plurality of exchanges to perform a second conversion between the crypto-currency amount and a second fiat-currency amount. The payment processor initiates a transfer of said second fiat-currency amount to the payee deposit destination.

### FIELD OF THE INVENTION

The present invention is generally related to the field of currency transactions. More specifically, it is related to the selecting a currency exchange for currency conversion transactions and to the use of multiple ways (rails) used for the delivery of a payment.

### DESCRIPTION OF THE RELATED ART

When dealing with financial transactions between countries, the currency of a sender is often exchanged for the local of the receiver. Currencies are publically traded on global foreign exchanges which sets a base bid and ask rate for each currency with respect to other currencies.

Currencies may be the fiat-currency of a country such as a US dollar, Euro, or Yen or may be a crypto-currency, of which bitcoin is one example. While fiat-currencies are usually exchanged at a bank or currency exchange using well established rules crypto-currencies transactions are based on a blockchain, a digital ledger used to record transactions, and are exchanged through crypto-exchanges. The term currency can be used generally to refer to both a fiat-currency and a crypto-currency. The term exchange can be used generally to refer to both a bank or currency exchange for fiat-currencies, and to refer to a crypto-exchange that utilizes a blockchain or similar technology to record exchanges. Exchange rates apply to conversions between two fiat-currencies, two crypto-currencies, or between a fiat-currency and a crypto-currency.

When the payments are exchanged, the process can be described as a “rail.” The rail can be visualized as the path the transaction takes from sender to receiver. A sender may deposit an amount of their local fiat-currency into their local bank account and initiate a transfer to a receiver in another country. The deposited fiat-currency may be exchanged at the bank into an intermediate currency and then transferred to the receiver. The route the transfer takes from bank to first exchange to second exchange is the rail that was utilized for the transaction. A payment transaction can use multiple rails to transfer an amount of currency from the sender to the receiver.

At any point in time, there is a global exchange rate between currencies that is decided by the large global exchanges or payment processors. Smaller exchanges will use a variation of the bid and ask rate that is based on the global exchange rate. The spread between the bid and ask rate represents part of the cost of the transaction. A small spread, the difference between the bid and ask rate, reduces the cost of the transaction while a large spread increases the cost. National banks, large banks, and large corporations transferring large amounts of currency typically benefit from a small spread. Smaller companies and individuals usually pay more.

As well as the spread between the rates, many exchanges charge a fee to the sender, the receiver, or both parties. The fees vary between exchanges but for most fiat-currency exchanges, the fees for a particular exchange vary slowly over time. When a sender or receiver requires a transfer of funds, the payment processor determines what rail to use for their transaction by querying the bank or exchange for their fees and their bid and ask prices for that day and decide which rail to use. When only using fiat-currencies and fiat-exchanges for the transaction, the task of choosing a rail to minimize costs can be done manually, by deciding to use one or two well known exchanges, or by using, computer aided methods

Crypto-currencies have the characteristics of being stateless, with transactions done on the Internet and with exchanges located in many countries of the world. Due to their locations and various factors in their home countries such as government regulations, as well as competition between exchanges, each offers different services and charge different rates for those services which may be taken advantage of by new technology. Furthermore, since they are accessed over the Internet, a larger number of crypto-currency exchanges can now be used for as currency exchange rails.

The exchange rates for crypto-currencies have historically also been extremely volatile with exchange rates versus fiat-currencies quickly changing by large amounts. One reason for the high volatility is the high speed of Internet trading and the speed at which both good and bad news is disseminated and received by investors and traders. The fees for crypto-currency exchanges also change quickly and may be difficult to track.

By allowing currency exchanges to use both fiat-currency exchanges and crypto-exchanges the number of exchanges is much larger than the case of only using fiat-currencies. The crypto-currency exchange rates and the volatility of fees charged by crypto-currency exchanges means that the best rail can change in real time. This leads to the situation where the number of possible of rails to use for a transaction becomes very large and the cost of utilizing different rails for the transaction can vary widely both between exchanges and over time.

A payment processor is a company that provides financial services that included the transfer of different currencies or same currencies from a sender to a receiver. The payment processor must charge fees to remain profitable while still offering competitive rates. Due to the use of multiple rails, the task for a payment processor of choosing a rail for a currency transaction is no longer a simple task and requires new methods in order to do it in a timely and effective manner.

It should be noted that not just currencies but other items of value such as precious metals and commodities may also be exchanged to and from fiat-currencies or with each other through exchanges.

### BRIEF SUMMARY

In one embodiment of the invention a payment processor receives a first fiat-currency amount and information comprising a payee deposit destination. The payment processor receives a first plurality of criteria and evaluates a first plurality of exchanges against the first plurality of criteria to select a first transaction exchange from the first plurality of exchanges to initiate a first conversion between a first fiat-currency amount and a cryptocurrency amount. The payment processor receives a second plurality of criteria and evaluates a second plurality of exchanges against the second plurality of criteria. The payment processor selects a second transaction exchange from the second plurality of exchanges to perform a second conversion between the crypto-currency amount and a second fiat-currency amount. The payment processor initiates a transfer of said second fiat-currency amount to the payee deposit destination.

In another embodiment of the invention a payment processor receives a first fiat-currency amount and information comprising a payee deposit destination. The payment processor receives a first plurality of criteria and assigns a least a first weighting to at least one of the first plurality of criteria and uses the first weighting to produce a first weighted criteria. The payment processor evaluates a first plurality of exchanges against at least one of the first plurality of criteria and the first weighted criteria, and selects a first transaction exchange from the first plurality of exchanges to initiate a first conversion between a first fiat-currency amount and a crypto-currency amount. The payment processor receives a second plurality of criteria, assigns at least a second weighting to at least one of the second plurality of criteria and uses the second weighting to produce a second weighted criteria. The payment processor evaluates a second plurality of exchanges against at least one of the second plurality of criteria and the second weighted criteria, and selects a second transaction exchange from the second plurality of exchanges to initiate a second conversion between the crypto-currency amount and a second fiat-currency amount. The payment processor initiates a transfer of the second fiat-currency amount to the payee deposit destination.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an overview of a transaction being made where exchanges are chosen using criteria.

FIG. 2 shows an overview of a transaction being made where exchanges are chosen using criteria and where payments may be made in the presence of reserves.

FIG. 3 is a flow chart of an implementation on computer hardware by a payment processor to choose a rail for financial transaction.

FIG. 4 is a diagram of a payment processor having a number of rails that can be used to transfer funds from and to different sources and destinations.

FIG. 5 is a more detailed diagram of a payment processor for sending funds in a crypto-currency.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

In one embodiment of the present invention, a configurable software module referred to as an “exchange router” uses criteria to select a rail, including currency exchanges, to be used in a currency conversion transaction where funds are transferred from a sender to a receiver. The exchange router also administers how an exchange is going to be used on a crypto-network when the transaction is processed. The module gathers dynamically changing cost and criteria input in real time from a variety of exchanges in order to choose an optimal rail for the transaction.

The exchange router is configurable through inputs that provide the criteria to evaluate exchanges. The input may be provided by one or more of the sender, receiver, payment processor, businesses, governments, banks, consumers, or any other organization. There may be a single input criteria or several where the criteria will vary depending on the needs of the parties involved in the financial transaction. A variety of criteria may be used but common ones include the bid and ask price of the currency as is commonly used today. Other criteria may include the maximum number of transactions in during a day, month, or other time period, minimum or maximum currency amount per transaction or during a time period. Criteria may be to use only fiat-currencies, crypto-currencies, or it may be allowable to use a combination of the two. Criteria may be selected and grouped to provide the basis of service level agreements (SLAs) between the sender or receiver and the payment processor.

Due to the stateless nature of crypto-currency exchanges there may also be criteria based on the fiat-currencies supported by the exchange as well as their liquidity for chosen fiat-currencies. The country where the exchange is located or registered in, what laws they operate under and what national or international regulations they abide by may also be of interest.

Other possible criteria may be the fees charged, cost per transaction, monthly fees, or other costs involved in the transaction. Additional criteria of interest may be related to payment types supported for payments in and out. Criteria related to exchange size and reliability may also be used, for example, size of the company that owns the exchange, amount of currency converted, number of conversions, and exchange uptime.

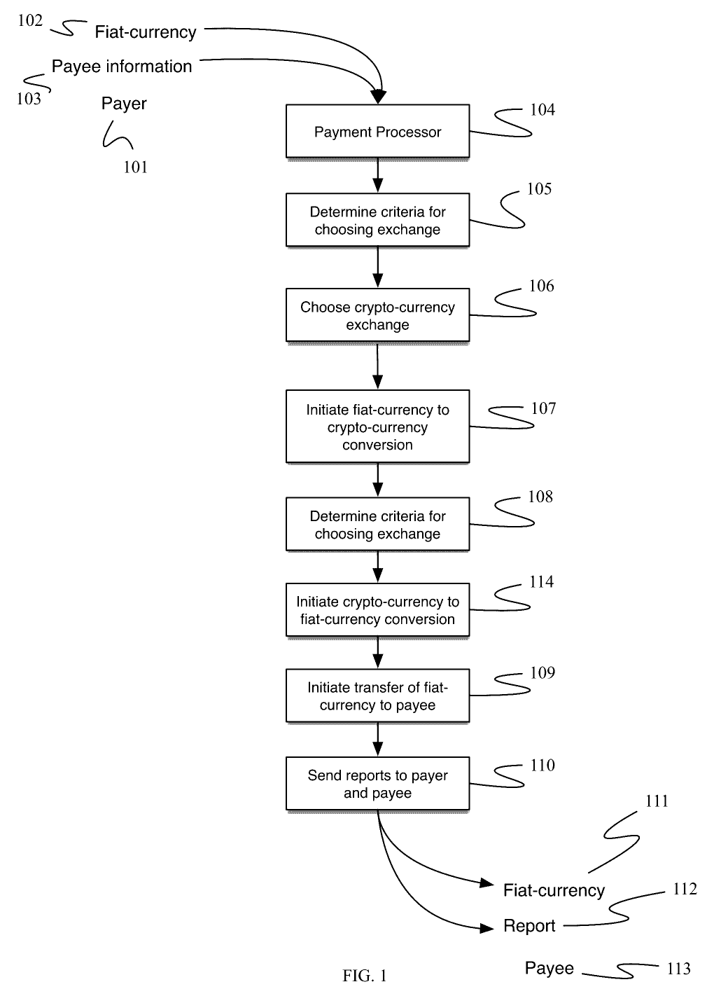

Referring to FIG. 1, an example of a crypto-currency financial transaction is the transfer of funds from a payer 101 in one country to a payee 113 in the same or another country using crypto-currency as a transport mechanism. In this type of transaction, a payer in a first country initiates a transfer using their home country fiat-currency 102 and specifying the payee's deposit destination information 103 such as a bank account and routing information. The payment processor will then convert the fiat-currency amount to an equivalent crypto-currency amount 107. Next the crypto-currency will be transferred to the payee's country using crypto-currency infrastructure as a transport mechanism. Finally, the crypto-currency is converted to a second fiat-currency 109, that is payee's home country fiat-currency, and paid to the payee. These steps are typically performed in the order above but could be done in any order given the level of trust and arrangements between the parties involved. In the above transaction there are two exchanges performed; from a first fiat-currency to crypto-currency and from the crypto-currency to a second fiat-currency. Both of these conversions may utilize the exchange server of this embodiment with the same or different criteria defined. The criteria could be defined by either the sender or the receiver of the transfer, the company providing the transfer infrastructure, government regulations or other entities. Criteria may be combined and may be decided at the time of transfer or in advance. For similar transfers done at different times, the criteria may change as well. The transaction uses a rail that uses two exchanges; a first exchange to convert the payee fiat-currency to crypto-currency and a second exchange to convert the crypto-currency to an equivalent amount of the payee's fiat-currency.

Each exchange has a weighting in the exchange router where the weighting gives it a relative priority compared to other exchanges. This is defined as the exchange weighting. When a transaction is available for processing, the router determines the exchange to use based on the weighting allocated for the exchange.

Though the embodiment above describes currency exchanges between crypto-currency and fiat-currencies the same embodiment can be used to exchange between crypto-currencies and between two fiat-currencies or any two similar or dissimilar assets. Exchanges can be fiat-currency exchanges such as banks and foreign exchange markets as well as crypto-currency exchanges based on technology of which blockchain is one example.

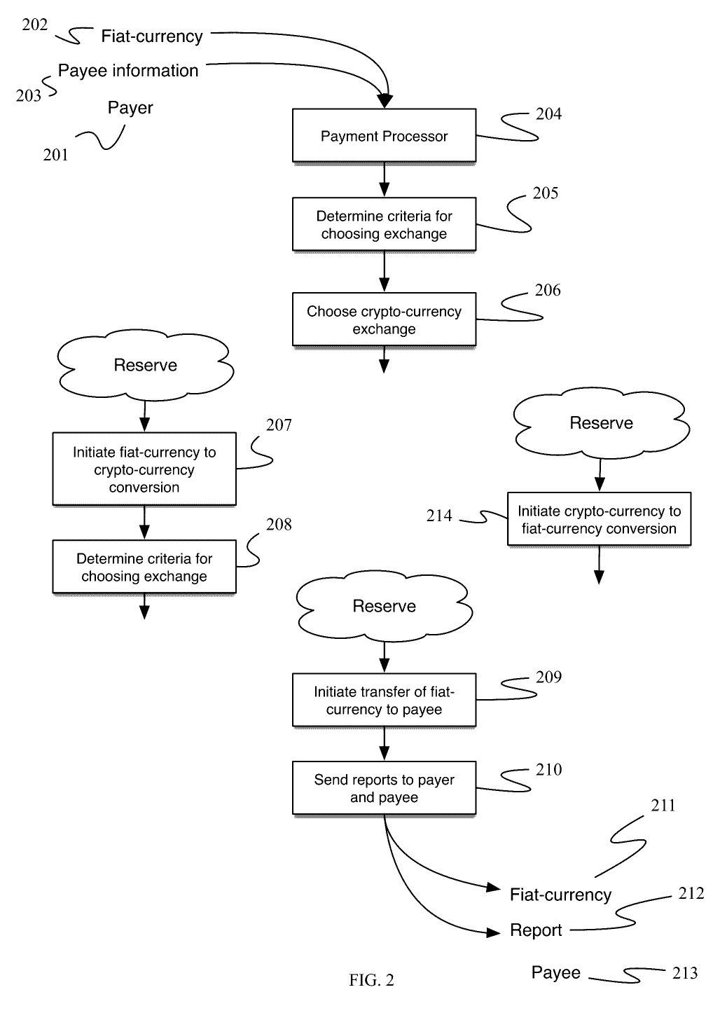

FIG. 2 illustrates another embodiment of a complex rail that does not involve a straight path from payer to payee. This crypto-currency financial transaction illustrates the transfer of funds from a payer 201 in one country to a payee 213 in the same or another country using crypto-currency as a transport mechanism where the presence of sufficient reserve funds allows for a payment to a payee to be made before other currency exchanges have completed or been confirmed.

In this type of transaction, a payer in a first country initiates a transfer using their home country fiat-currency 203 and specifying the payee's deposit destination information 203 such as a bank account and routing information. The payment processor determines one or more exchanges to use for the fiat-currency to crypto-currency 206, crypto-currency to fiat-currency 208, and any crypto-currency to crypto-conversions required using criteria as defined. The criteria 205 could be defined by either the sender or the receiver of the transfer, the company providing the transfer infrastructure, government regulations or other entities. Criteria may be combined and may be decided at the time of transfer or in advance. For similar transfers done at different times, the criteria may change as well, the will then convert the fiat-currency amount to an equivalent crypto-currency amount. The conversions form a chain and in this embodiment the presence of a reserve fund in the correct currency at any part of the chain allows for that transfer to be made before currency is received from the previous link in the chain. For example, a payee may receive their payment 209 in their local fiat-currency 211 should the local crypto-currency to fiat-currency exchange hold a reserve in the local currency and make the payout before receiving crypto-currency received from the payee's initiated transaction.

In general, the steps in the processes described herein may be performed in any order given reserve levels, contractual agreements, or other arrangements as agreed to by one of more of the parties involved.

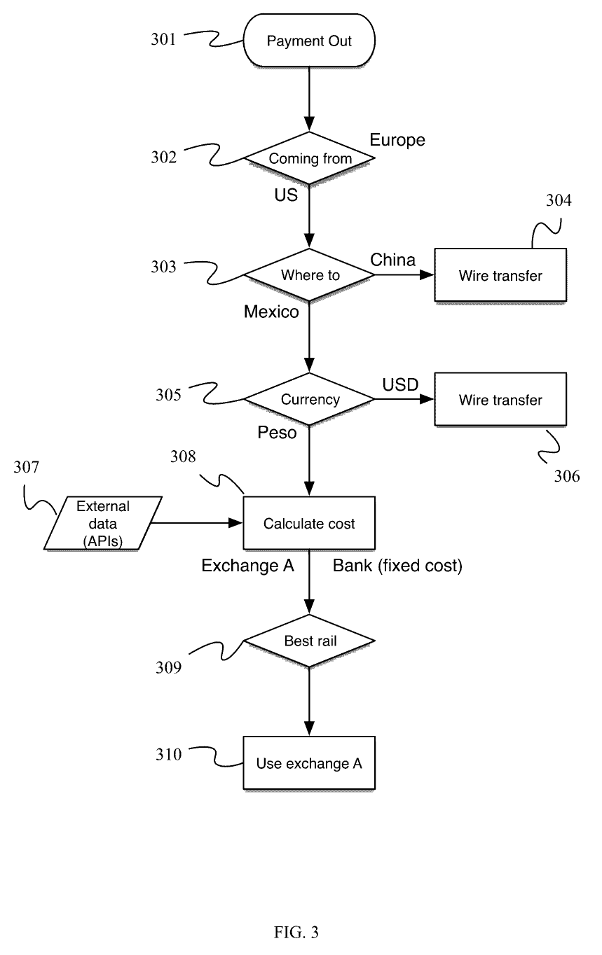

FIG. 3 illustrates an embodiment of the invention as implemented on computer hardware by a payment processor to choose a rail for financial transaction. A transaction can be initiated by either a payer (sender) or a payee (receiver). A payer may have received an invoice to pay, may be required to make a payment in advance of a shipment, or may simply want to transfer funds to another party. A payee may want to initiate a transaction to request funds as in sending an invoice to another party. Both the sender and the receiver are registered with the payment processor or will be registered as part of the process and this will include information required to comply with KYC (know your customer) and AML (anti-money laundering) requirements as required by governments or by the sender or the receiver. KYC requirements may also be required by an exchange or a third party who may be guaranteeing the transaction or acting as an escrow agent.

In the present example, once the payment 301 is defined and information gathered the payment processor starts to collect key parameters of the transaction. This can be looking at the source 302 and the destination 303. In the example given the funds are being transferred from the United States and the payment processor reads in a first set of criteria that are relevant for transfers originating from the United States. These criteria may vary depending on the originating country and may vary depending on the information provided by the sender, the amount of the transaction and other criteria as described in U.S. patent application Ser. No. 14/919,909 hereby incorporated by reference in its entirety. The payment processor will also look at the destination of the transfer 303 and this will dictate a second set of criteria that is added to the first set. In the example given the destination may be Mexico or China. Assuming that China 304 does not permit crypto-currency transfers, then a traditional wire transfer will be used to pay out the transfer to the receiver. Assuming that Mexico does permit both wire transfers and crypto-currency transfers then, the receiving currency will be examined 305 and this lead to a third set of criteria being added. In this case if the payment is made from the United States to Mexico in US dollars then crypto-currencies may not be used and a wire transfer is chosen 306. In this case, by making a transfer from the United States to Mexico where the payee receives funds in peso there exist rails that utilize both traditional wire transfer exchanges and crypto-currency exchanges and the payment processor. In this case, due to the large number of options in rails and the high volatility of both the exchange rate of crypto-currencies and the fees charged by the various exchanges the calculation of the cost 308 of the rails is non-trivial and is performed by the payment processor.

The calculation of the the cost 308 of the available rails starts with the use of computer implemented API (application programming interfaces) to automatically query the banks and exchanges that make up the possible rails for the transfer. Each exchange and bank will return different data in different formats and this must be normalized by the payment processor in order to compare them. The costs will then be evaluated against the criteria. A variety of criteria may be used but common ones include the bid and ask price of the currency as is commonly used today. Other criteria may include the maximum number of transactions in during a day, month, or other time period, minimum or maximum currency amount per transaction or during a time period. Criteria may include the amount of time required to complete a transaction. Further criteria may include the amount, detail, and accuracy of the reporting provided by the rail. Criteria may be to use only fiat-currencies, crypto-currencies, or it may be allowable to use a combination of the two. Criteria may be selected and grouped to provide the basis of service level agreements (SLAs) between the sender or receiver and the payment processor. This may be combined with reporting in order to determine if the SLA conditions have been fulfilled. Due to the stateless nature of crypto-currency exchanges there may also be criteria based on the fiat-currencies supported by the exchange as well as their liquidity for chosen fiat-currencies. The country where the exchange is located or registered in, what laws they operate under and what national or international regulations they abide by may also be of interest. Other possible criteria may be the fees charged, cost per transaction, monthly fees, or other costs involved in the transaction. Additional criteria of interest may be related to payment types supported for payments in and out. Criteria related to exchange size and reliability may also be used, for example, size of the company that owns the exchange, amount of currency converted, number of conversions, and exchange uptime.

The querying of the banks and exchanges must be done in a timely manner as close to the time of the payment processor evaluating rails to ensure that highly volatile data is as up to date as possible. The payment processor may maintain a table of costs that include when they were last updated and an indication of their volatility. Highly volatile costs may have to be updated frequently while low volatility costs may be updated infrequently.

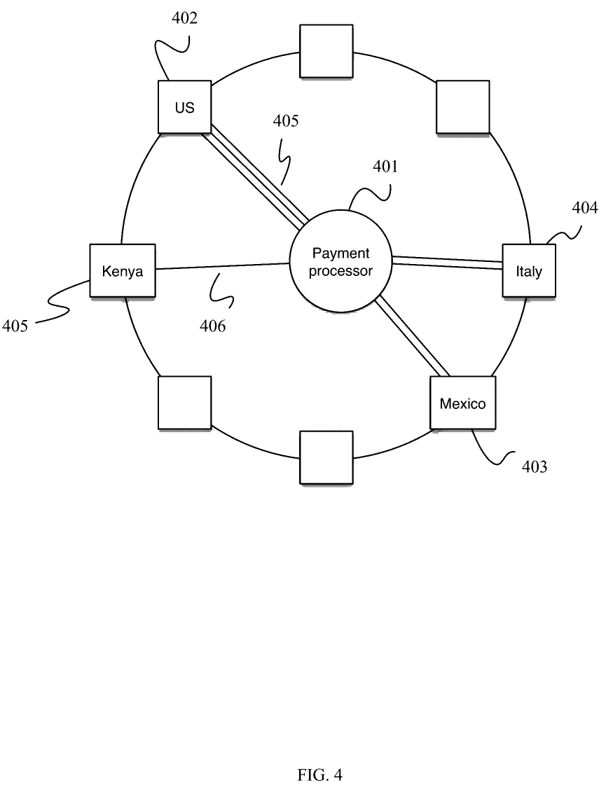

The evaluation of the criteria will lead to a cost per rail for each possible rail that can implement the transaction. Referring to FIG. 4, each source and destination, in this illustrative example the United States 402, Kenya 405, Mexico 403, and Italy 404 have a number of rails that can be used to transfer funds from and to them. Rails may be bi-directional or unidirectional. Unidirectional transfers are where currencies may be transferred in or out using a particular exchange but not both. A country such as the United States will have a large number of available rails 405 while a smaller country such as Kenya may have only one available rail 406. Rails may incorporate a single or multiple exchanges and may be able to convert all or only some fiat-currencies and crypto-currencies.

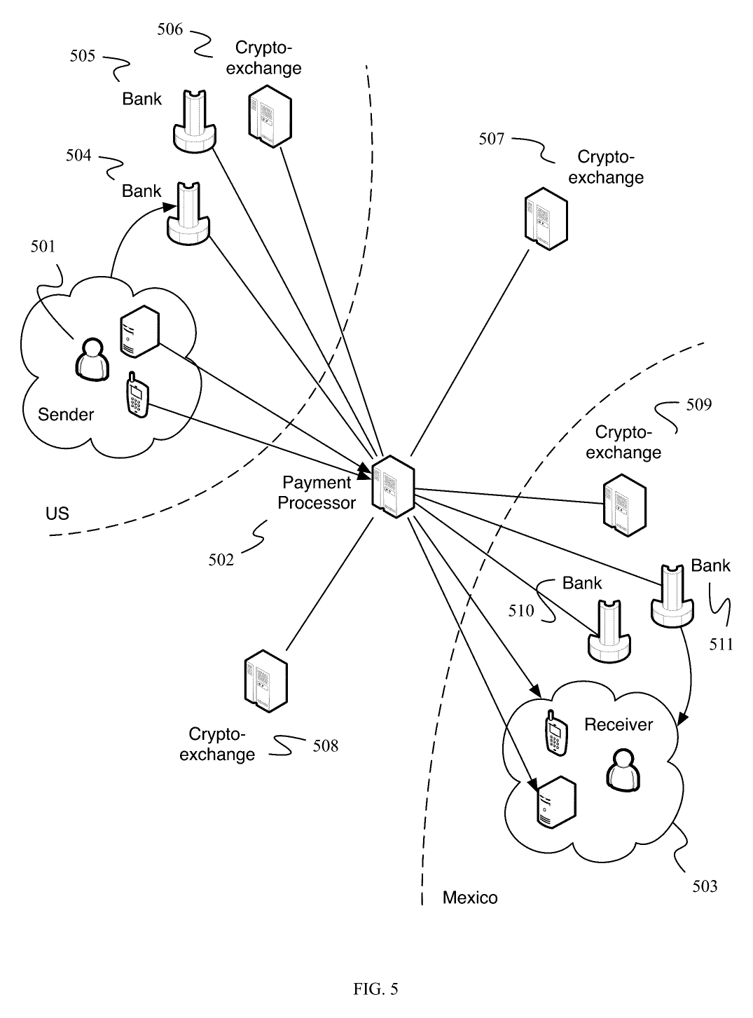

FIG. 5 shows a geographical view of an embodiment of the invention. The sender is located in the US 501 and may initiate or respond to transactions using a personal computer, mobile device, telephone or other means of communication. The interface using a personal computer or mobile device may be a customized web page or a local application that allows the use to register, authenticate with the payment processor, provide identification for themselves and the receiver, and communicate with the payment processor to verify their identity in link with KYC criteria. The user interface also allows them to specify general criteria to be used with all of their transactions as well as specific criteria. Specific criteria may apply to sending payments, receiving payments, to certain receivers or groups of receivers. Specific criteria may apply to receivers in certain countries, or that use certain currencies, including crypto-currencies. For example; criteria may apply to receivers in Mexico that want to receive payment in bitcoin and are in the telecommunications industry. Other criteria may apply to receivers in Germany who want to receive payment in Euro and have overdue payments due to the sender.

The sender 501 interfaces to the payment processor 502 who may be located in the same country as the sender or the receiver, or somewhere where neither is located. If the sender is sending in fiat-currency they will typically interface with one of the local banks 504, or another local bank 505. If they are sending funds in a crypto-currency they may use one located in their home country 506, or one in the receiver's country 509, or one located elsewhere such as 507 or 508. Similar to the sender, the receiver 503 may initiate or respond to transactions using a personal computer, mobile device, telephone or other means of communication. The interface using a personal computer or mobile device may be a customized web page or a local application that allows the use to register, authenticate with the payment processor, provide identification for themselves and the receiver, and to communicate with the payment processor to verify their identity in link with KYC criteria. The user interface also allows them to specify general criteria to be used with all of their transactions as well as specific criteria.

The receiver 503 may receive payout in the fiat-currency of their choice using a local bank 511 from among a choice of local banks 510. They may receive payment in a crypto-currency through a crypto-exchange that is local 509, in the sender's country 506, or located elsewhere such as 507 508.

The payment processor will evaluate the transaction data and its associated criteria as well as criteria supplied by the sender and the receiver. The payment processor will determine the optimal rail for the transaction given the criteria. The payment processor may also determine redundant or back-up rails that could also be used to complete the transaction. These redundant rails may have the same cost, or the same overall cost but may have higher scores or lower costs in different criteria from the primary rail. The payment processor may have criteria to decide when to use a redundant rail or may give the choice to the sender or the receiver.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method of electronic commerce payments comprising:
a payment processor receiving a first fiat-currency amount and information, said information comprising a payee deposit destination,
said payment processor receiving a first plurality of criteria, evaluating a first plurality of exchanges against said first plurality of criteria, and selecting a first transaction exchange from said first plurality of exchanges to initiate a first conversion between a first fiat-currency amount and a crypto-currency amount,
said payment processor receiving a second plurality of criteria, evaluating a second plurality of exchanges against said second plurality of criteria, and selecting a second transaction exchange from said second plurality of exchanges to perform a second conversion between the crypto-currency amount and a second fiat-currency amount,
said payment processor initiating a transfer of said second fiat-currency amount to the payee deposit destination.

2. A process of selecting an exchange comprising:
receiving a plurality of criteria,
evaluating a plurality of exchanges against said plurality of criteria, and
selecting an transaction exchange from said plurality of exchanges to perform a conversion between a first asset and a second asset.

3. A method of electronic commerce payments comprising:
a payment processor receiving a first fiat-currency amount and information, said information comprising a payee deposit destination,
said payment processor receiving a first plurality of criteria, assigning at least a first weighting to at least one of said first plurality of criteria and using said first weighting to produce a first weighted criteria,
evaluating a first plurality of exchanges against at least one of said first plurality of criteria and said first weighted criteria, and selecting a first transaction exchange from said first plurality of exchanges to initiate a first conversion between a first fiat-currency amount and a crypto-currency amount,
said payment processor receiving a second plurality of criteria, assigning at least a second weighting to at least one of said second plurality of criteria and using said second weighting to produce a second weighted criteria,
evaluating a second plurality of exchanges against at least one of said second plurality of criteria and said second weighted criteria, and selecting a second transaction exchange from said second plurality of exchanges to initiate a second conversion between the crypto-currency amount and a second fiat-currency amount,
said payment processor initiating a transfer of said second fiat-currency amount to the payee deposit destination.

4. A process of selecting an exchange comprising:
receiving a plurality of criteria,
assigning at least one weighting to at least one of said plurality of criteria and using said weighting to produce a weighted criteria,
evaluating a plurality of exchanges against at least one of said plurality of criteria and said weighted criteria, and
selecting an transaction exchange from said plurality of exchanges to perform a conversion between a first asset and a second asset.
